(19) United States
(12) Patent Application Publication
(10) Pub. No.: US 2012/0017895 A1
(43) Pub. Date: Jan. 26, 2012

(54) RESPIRATOR KIT AND CONTOURED PLENUM THEREFOR

(75) Inventors: Greg A. Tilley, Monkton, MD (US); James Wilcox, Baltimore, MD (US)

(73) Assignee: AVON PROTECTION SYSTEMS, INC., Cadillac, MI (US)

(21) Appl. No.: 13/147,766

(22) PCT Filed: Feb. 2, 2010
(86) PCT No.: PCT/US10/22855

§ 371 Date: Aug. 3, 2011

Related U.S. Application Data
(60) Provisional application No. 61/149,531, filed on Feb. 3, 2009.

(51) Int. Cl. A62B 18/08; A62B 18/10

(52) U.S. Cl. 128/202.15; 128/205.25; 128/205.12; 128/205.24; 128/204.21

(57) ABSTRACT

A respirator kit which includes a contoured plenum; a breathing mask or hood; an air supplying device, such as a powered air purifying respirator or self contained breathing apparatus; and an air hose. The contoured plenum has a low-profile and can be fluidly connected between the respirator mask and hose, and replaces the conventional air hose connection traditionally associated with powered air devices. The plenum is contoured to follow the profile of the mask, reducing the profile of the airway into the mask. The plenum includes a connector by which the plenum can be attached to the inlet of the mask, and can also include a demand valve.

### CROSS REFERENCE TO RELATED APPLICATIONS

This application claims priority to U.S. Provisional Patent Application Ser. No. 61/149,531, filed Feb. 3, 2009, which is incorporated herein by reference in its entirety.

### BACKGROUND OF THE INVENTION

1. Field of the Invention

The invention relates to powered air purifying and air-supplied respirators. In one of its aspects the invention relates to a respirator kit with a plenum having a low-profile, contoured shape. In another of its aspects, the invention relates to a respirator with a low profile, contoured plenum for use with a compact demand valve. In another of its aspects, the invention relates to a contoured plenum that is adapted to be removably mounted to an air hose and a respirator mask.

2. Description of the Related Art

Respirators for purifying ambient air and for providing a breathable air supply to a wearer are well-known devices that are utilized by firefighters, military personnel, and in other settings where individuals can potentially be exposed to a contaminated air supply. Such respirators can include masks, hoods, and/or face shields for securing the respirator to the wearer's face and for further protecting the wearer. Respirator masks are typically adapted to receive a variety of filter cartridges or air supply connectors to provide a source of breathable air to the wearer.

There are multiple varieties of respirators that offer differing levels of protection, the two major classes being positive and negative pressure respirators. In a negative pressure respirator, which is the simplest type of respirator, the air pressure inside the mask is negative during inhalation with respect to the ambient pressure outside the respirator. As the user inhales, air is drawn from the ambient atmosphere, through an air purifying filter, and into the mask. The user then exhales through an exhalation unit typically comprising a check valve that provides a relatively small exhalation resistance. Such respirators are sufficient for certain environments, but can be susceptible to contamination if any leaks develop in the respirator or between the mask and the wearer.

A higher level of protection is provided by a powered air purifying respirator (PAPR), wherein the air pressure inside the mask is slightly positive during inhalation with respect to the ambient pressure outside the respirator. In this type of respirator, the filter attaches to a canister with a fan or blower, preferably battery operated, that forces air through the filter, and then the purified air with positive pressure runs through a hose to the mask. The exhalation resistance of the check valve in the exhalation unit can be higher than in a negative pressure respirator.

A third type of respirator system is a self-contained breathing apparatus (SCBA), which includes an air tank that is usually worn on a user's back and contains compressed purified air. The tank provides positive pressure air to the mask through a pressure reducing valve to step down the air pressure to an acceptable level. Air enters the mask through a demand valve that opens when the user inhales. Logically, the cracking pressure of the exhalation unit check valve used with the SCBA system is greater than that for use in the PAPR system and is greater than the cracking pressure of the demand valve to prevent continuous flow of air through the respirator. In this way, air flows into the respirator during inhalation but ceases to flow during exhalation. Although the supply of air in the SCBA is limited by the volume of the tank, the SCBA respirator system is portable and highly effective in environments where the air is highly contaminated and dangerous, such as in firefighting.

Alternatively, the respirator can be utilized as a closed circuit breathing apparatus (CCBA), wherein an exhale hose is attached at one end to the exhalation unit and at the opposite end to the respirator inlet connection. Hence, the respirator and the exhale hose form a closed breathing loop. During use, the user exhales through the exhalation unit, through the air purification means, and back into the respirator via the inhalation hose of the CCBA circuit.

As respirators are used in a variety of emergency or even combat situations, it is undesirable to have a bulky connection between the respirator mask and the supplying air hose. A connection that considerably protrudes from the mask increases the risk to the wearer of snagging the mask on something, or having the hose grabbed or ripped away from the mask by an attacker. Another drawback to the typical hose connection of the prior art is that it does not easily follow the up and down movement of the user's head, instead the free length of hose is moved and not just rotated at the airway connection.

### SUMMARY OF THE INVENTION

According to the invention, a respirator kit comprises a respirator mask having an inlet opening for admitting air into the mask, a source of pressurized air, and a hose adapted to be connected to the source of pressurized air at one end and having a distal end, and a plenum adapted to be connected to the hose distal end and with the mask inlet opening. The plenum has a mask end and a hose end and is adapted to be positioned alongside a side of the mask along the length of the plenum when the plenum is attached to the mask.

Further according to the invention, a low-profile plenum for use with a respirator comprises a mask end that is adapted to be connected to a mask inlet opening and a hose end that is adapted to be connected to a hose distal end and wherein the plenum is configured to be positioned alongside a side of the mask along the length of the plenum when the plenum mask end is connected to the mask inlet opening.

In one embodiment, the mask has a hose or filter connector at the inlet opening and the plenum has a mask connector that is adapted to connect the plenum to the hose or filter connector. In another embodiment, the mask connector is integrated into the plenum to provide a low-profile connection between the mask and the plenum.

In another embodiment, the mask connector is rotatably mounted to the plenum so that the plenum can rotate about the connector with respect to the mask. The plenum has a connector seat and the mask connector is rotatably mounted in the connector seat. Further, there is a seal between the connector seat and mask connector. In addition, the plenum connector seat is clamped between the mask connector and the hose or filter connector and the mask connector has a handle on an exterior surface for rotating the mask connector with respect to the plenum.

In one embodiment, the hose or filter connector and mask connector have complementary bayonet connections. Alternatively, the hose or filter connector and mask connector can have complementary threaded connections.

In another embodiment, the plenum seat comprises a seat sleeve to which the mask connector is mounted. Further, the mask connector comprises a connector sleeve which is received over the plenum seat sleeve and the mask connector sleeve is axially retained on the plenum seat sleeve but rotatably mounted thereto.

In a preferred embodiment, the plenum comprises a plenum body and a gaiter, and the plenum body is configured to closely follow the contour of the mask. The plenum body is elongated and is configured to have a self-supporting structural integrity. Further, the plenum body has an elongated axial geometry and an elongated cross-sectional configuration at least along a portion of the length of the plenum body adjacent to the mask connector. More specifically, the plenum body has a cross-sectional configuration that changes from a relatively flat elliptical shape to a circular shape between the mask end and the hose end.

Alternatively, the plenum body can have a cross-sectional configuration that has a relatively flat elliptical shape between the mask end and the hose end.

In yet another embodiment, the gaiter can be a flexible conduit with a hose connection for connecting to the hose distal end. In addition, there is a connector between the gaiter and headgear associated with the mask for supporting the hose end of the plenum. Also, the gaiter has an elbow.

In another embodiment, the plenum has a demand valve adapted to control the flow of air through the plenum. The plenum can also have a remote power switch by which to control power to the source of pressurized air, a hydration tube mounted to the plenum and adapted to be connected to the mask, and a light pipe adapted to be connected to the mask.

### BRIEF DESCRIPTION OF THE DRAWINGS

In the drawings:

FIG. 1 shows a respirator kit having a contoured plenum according to a first embodiment of the invention and illustrating the air flow path of the respirator through the contoured plenum.

FIG. 2 is a perspective view of the contoured plenum illustrated in FIG. 1 and according to the invention.

FIG. 3 is a perspective view of a plenum body of the contoured plenum shown in FIG. 2.

FIG. 4 is a perspective view of a gaiter of the contoured plenum shown in FIG. 2.

FIG. 5 is a perspective view of a connector of the contoured plenum shown in FIG. 2.

FIG. 6 is a cross-sectional view of the plenum of FIG. 2, taken along line 6-6 of FIG. 2.

FIG. 7 is a perspective view of a respirator kit having a contoured plenum according to a second embodiment of the invention and illustrating the flow path through the respirator.

FIG. 8 is a perspective view of the contoured plenum shown in FIG. 8 and according to the invention.

FIG. 9 is a perspective view of a plenum body of the contoured plenum shown in FIG. 8.

FIG. 10 is a perspective view of a plenum cap of the contoured plenum shown in FIG. 8.

FIG. 11 is a perspective view of a plenum body assembly of the contoured plenum shown in FIG. 8.

FIG. 12 is a perspective view of a connector of the contoured plenum shown in FIG. 8.

FIG. 13 is a cross-sectional view of the plenum of FIG. 7 taken along line 13-13 of FIG. 8.

### DESCRIPTION OF EMBODIMENTS OF THE INVENTION

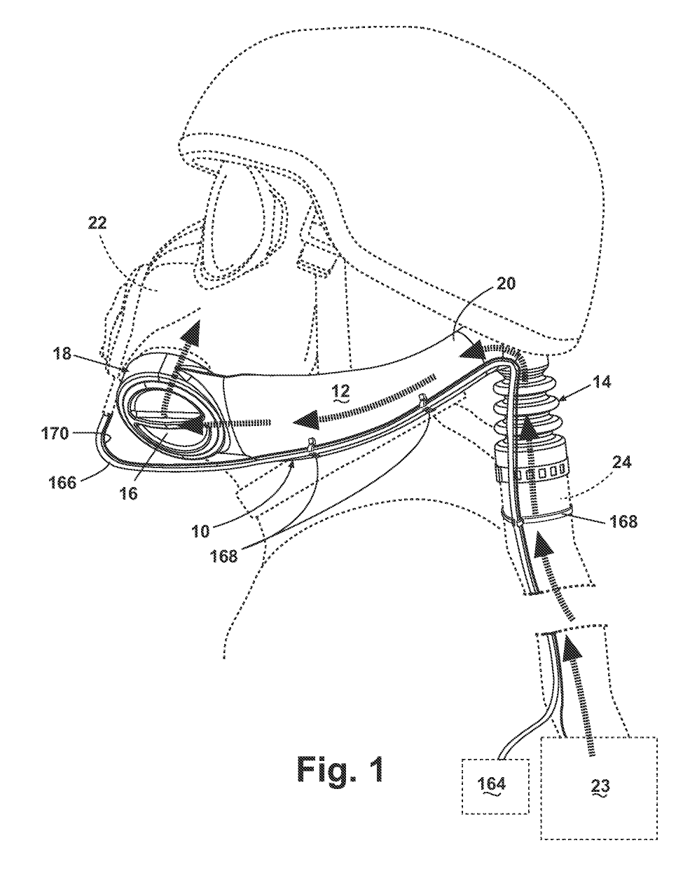

Referring to the drawings and to FIG. 1 in particular, a respirator generally comprises a conventional breathing mask 22 or hood (not shown) having in inlet opening 22A; a contoured air plenum 10, an air supply 23, such as a powered air purifying respirator (PAPR) or self contained breathing apparatus (SCBA), to provide pressurized, purified air; and an air hose 24. The plenum 10 comprises a plenum body 12, a flexible gaiter 14, and a mask connector 16. Respirator masks 22 are well known, and can include a self-sealing inlet port generally indicated at 22A (not shown in detail) that has a connector for affixing a filter canister or air supply hose. An example of such a respirator mask with a self-sealing inlet port is disclosed in U.S. Pat. No. 7,213,595, which is incorporated herein by reference. The air supply 23 can be one of several non-limiting types, such as a PAPR or SCBA. A PAPR is generally comprised of a filter attached to a housing containing a fan or blower that draws air through the filter, the purified air with positive pressure then flows through a hose 24 to the mask 22. Such a powered respirator is disclosed in PCT International Application No. PCT/US2008/084158, filed Nov. 20, 2008 and entitled “MODULAR POWERED AIR PURIFYING RESPIRATOR”, which is incorporated herein by reference. A SCBA is generally comprised of an air tank that is usually worn on a user's back and contains compressed purified air, an air hose 24, a demand valve, and a mask 22. The tank provides positive pressure air to the mask 22 through a pressure reducing valve to step down the air pressure to an acceptable level. Air enters the mask through a demand valve that opens when the user inhales. The respirator of the invention also includes a contoured plenum 10, which is a device that facilitates the movement of air from a PAPR or SCBA to a mask 22 or hood and replaces the need for the conventional air hose connection traditionally associated with powered air devices.

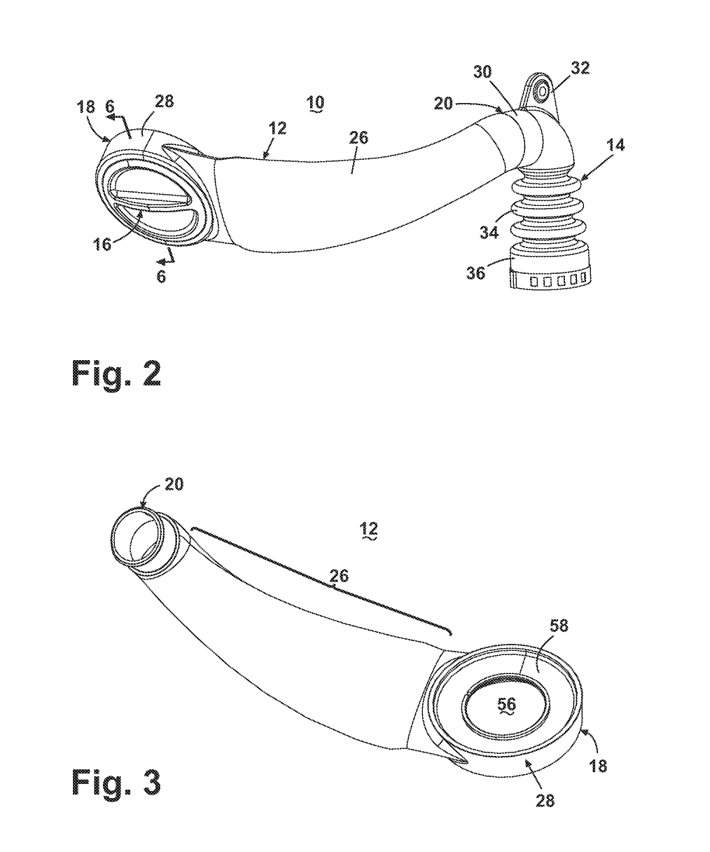

Referring to FIGS. 1 and 2, the plenum body 12 has a mask end 18 and a hose end 20 located at opposite ends of the plenum body 12. The mask end 18 and hose end 20 are integral to the plenum body 12. The mask connector 16 is rotatably and fluidly connected to the plenum body 12 at the mask end 18. Attached to the plenum body 12 at the hose end 20 is the flexible gaiter 14, which is also in fluid communication with the plenum body 12. The plenum 10 is adapted to be threadably or otherwise mounted to the respirator mask 22 and clamped to the air hose 24. For example, the plenum can be mounted to the respirator mask 22 by a snap fit of by a bayonet fitting as disclosed, for example, in U.S. Pat. No. 6,860,267. The plenum is preferably molded of a material that is rigid or semi-rigid so that it can be self-supported by the connection to the mask 22 to maintain a close contour along the mask 22. Suitable materials include plastic, rubber, or any other suitable material that to gives the plenum 10 the structural integrity to closely follow the contour of the mask 22.

Referring to FIG. 3, the plenum body 12 is elongated and comprises a main body segment 26 and a connector seat 28. The plenum body 12 is hollow, and the main body segment 26 can have any cross-sectional configuration, but is preferably ovate. In the embodiment shown, the cross-section of the main body segment 26 gradually transitions from circular at the hose end 20, to a relatively flat ellipse near the mask end 18. The connector seat 28 is integrally formed in the plenum body 12 at the mask end 18 of the main body segment 26. The connector seat 28 is generally circular and provides a means, described in detail below, by which the connector 16 (FIG. 1) is sealingly seated. The connector seat 28 includes a center hole 56, a circumferential flange 58, a groove 60, and an outer peripheral wall 62. The wall 62 seamlessly joins the flange 58 and groove 60, creating an interior space 64 within the connector seat 28. The interior space 64 fluidly connects the hollow plenum body 12 and the connector 16. The plenum body 12 acts as an air flow conduit that fluidly communicates the mask 22 with the gaiter 14 and hose 24.

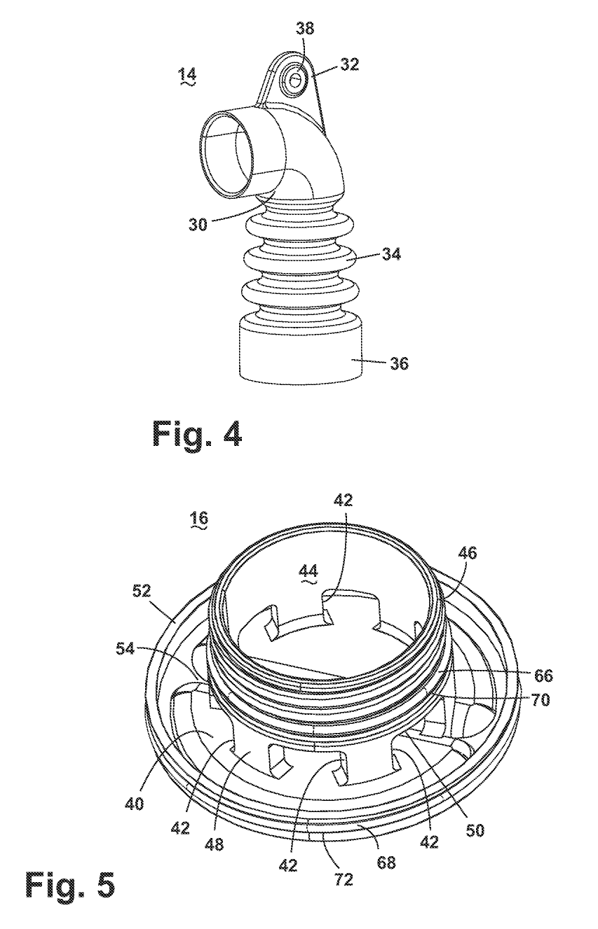

Referring to FIG. 4, the gaiter 14 is comprised of an elbow 30, an ear 32, a flexible corrugated conduit 34, and a collar 36, all of which can be formed in plastic, rubber, or any other suitable material for flexibility. In the embodiment shown, the gaiter 14 has a 90° elbow 30, however, other suitable angles are feasible. The gaiter 14 is hollow and generally tubular, and can be fluidly connected to the plenum body 12 at one end, and to the hose 24 at the other end. The conduit 34 terminates in the collar 36 to which the hose 24 can be sealed. The hose 24 and collar 36 can be clamped together by a conventional ring clamp. However, other suitable methods are feasible by which to fluidly connect the hose 24 and gaiter 14, for example a threaded engagement. The opposite end of the gaiter 14 is sealed to the plenum body 12 in any suitable air-tight fashion, such as by a suitable adhesive. The ear 32 has a grommet 38 through which the gaiter 14 can be attached, for example, to the mask 22 harness (not shown), a helmet (see FIG. 1), or other type of head gear. Attaching the gaiter 14 to the head gear supports the distal end of the plenum 10 to keep it from sagging due to the weight of the hose 24, and carries the plenum 10 with the movement of the wearer's head motion.

Referring to FIG. 5, the connector 16 is adapted to mount the plenum 10 to a facepiece of a respirator mask 22 and comprises a grip plate 40, an externally threaded sleeve 46 extending upwardly from the grip plate 40 and having a number of spaced inlet openings 42 and defining an outlet opening 44. The externally threaded sleeve 46 is advantageously used to couple the plenum 10 to a conventional internally threaded inlet (not shown) of a respirator mask 22. The grip plate 40 includes a lip 52 and a handle 54, all of which are integrally formed in the connector 16. The lip 52 is a wall which extends from the surface of the grip plate 40, and follows the outer periphery of the grip plate 40. The handle 54 is located on the exterior face of the connector 16, opposite the wall 48, and is defined by a ridge that the user can grasp to couple the connector 16 to the mask 22. The connector 16 is sealed to the connector seat 28 by two o-rings 66, 68. The first o-ring 66 is seated in a groove 70 about the circumference of the sleeve 46. The second o-ring 68 is seated in a second groove 72 about the circumference of the lip 52 on the connector 16. Alternatively, the plenum 10 can have a bayonet attachment as disclosed in U.S. Pat. No. 7,213,595 and the mask 22 face piece can have a complementary bayonet attachment for a quick attachment. Or, the plenum 10 can be attached to the mask 22 by a clip, or other suitable device.

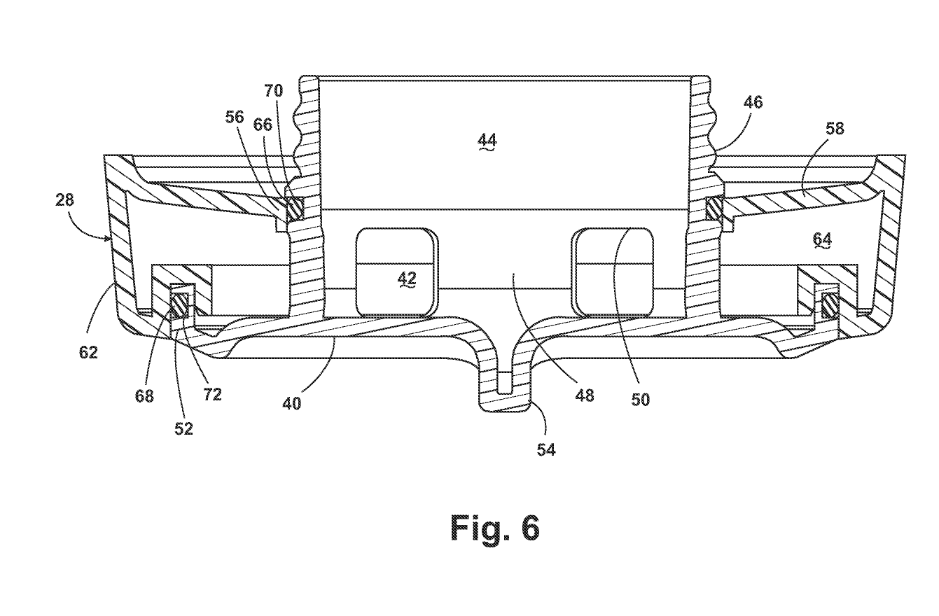

Referring to FIG. 6, a cross-sectional view of the connector 16 and connector seat 28 is shown. The connector 16 can be inserted through the center hole 56 on the connector seat 28. The connector seat 28 circumferential flange 58 sealingly contacts the o-ring 66 and cylindrical wall 48 of the connector 16. The connector seat 28 and connector 16 are also sealed by o-ring 68 at the interface where the groove 60 receives the connector 16 lip 52. This arrangement of the connector 16 and connector seat 28 allows the connector 16 to be able to rotate within the connector seat 28, so that the user can threadably screw the plenum 10, via the connector 16, to the mask 22. Screwing the connector 16 to the inlet 22A (not shown) of the mask 22 clamps the connector seat 28 between the connector 16 and the inlet 22A, retaining the plenum 10 to the mask 22. The arrangement of the connector 16 and connector seat 28 also allows the plenum 10 to rotate around the affixed connector 16 and follow the user's up and down head motion.

In operation, the hose 24 can be connected to a PAPR module or SCBA. The plenum 10 is coupled to the hose 24 as described above and the connector 16 is attached to the mask 22 as described above. The plenum 10 can also be secured, via the ear 32, to one of the mask 22, mask harness, or other head gear to facilitate proper positioning of the plenum 10. The hose 24, plenum 10, and mask 22 are thus sealingly and fluidly connected and can provide the wearer with a source of breathable air from the PAPR module or SCBA.

Referring back to FIG. 1, the respirator's air flow path is illustrated. Air flows from the PAPR or SCBA, through the hose 24 and gaiter 14, into the plenum body 12 and then the interior space 64 within the connector seat 28, through the connector 16 inlet 42 and out through outlet 44, and finally into the inlet of the mask 22 and to the wearer.

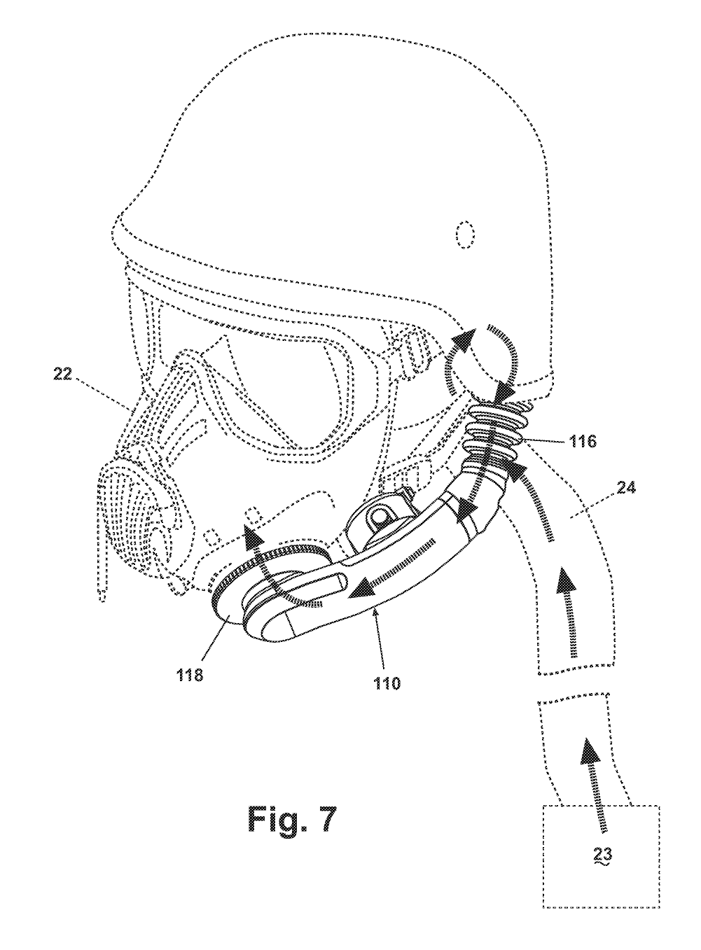

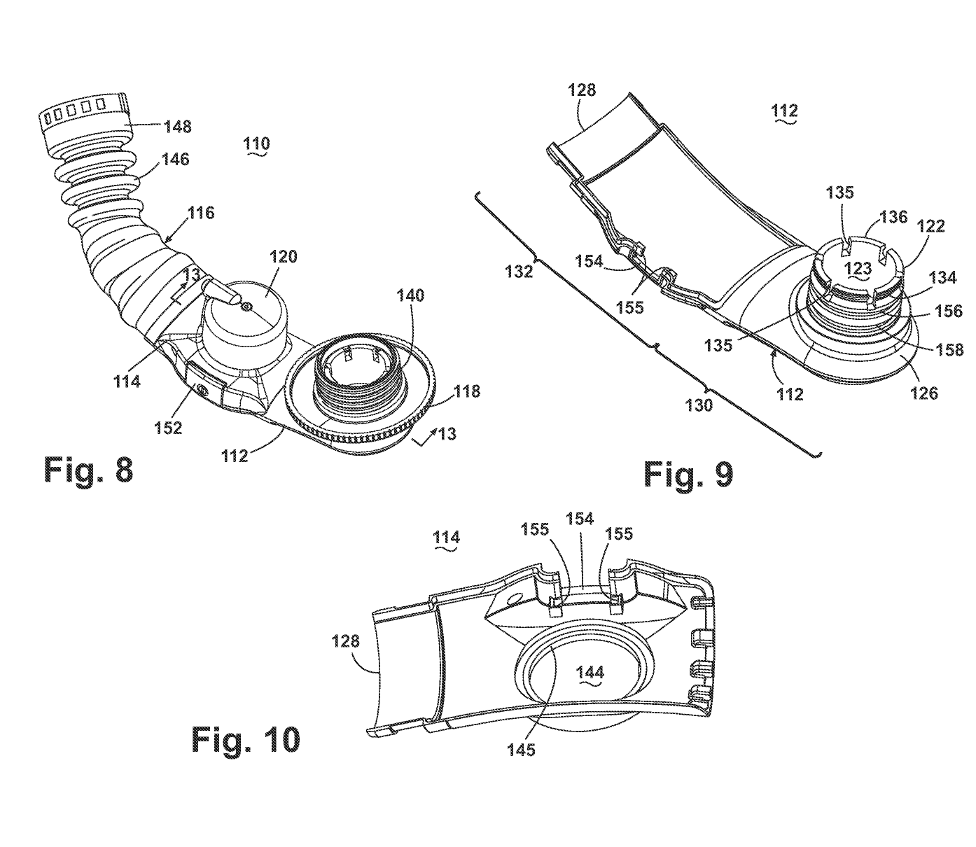

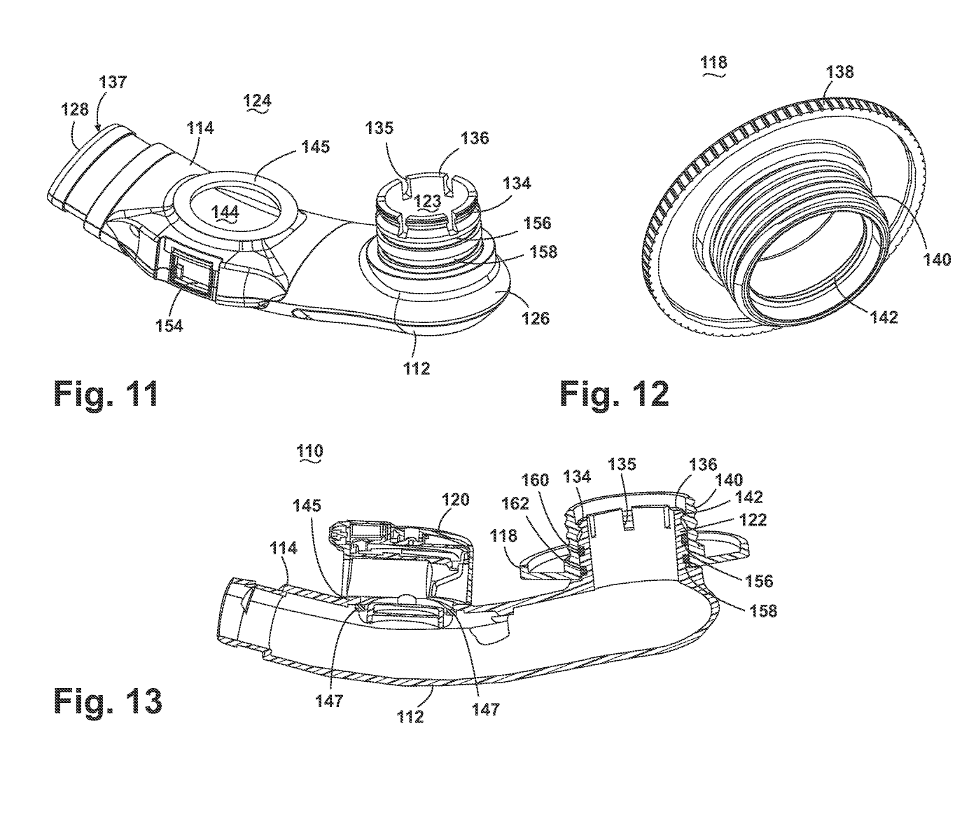

Referring to FIGS. 7 and 8, a second embodiment of a contoured plenum 110 according to the present invention is illustrated, where like elements from the first embodiment are labeled with the same reference numerals. In this embodiment, the plenum 110 comprises a main plenum body 112, a plenum cap 114, a flexible gaiter 116, a mask connector 118, and a compact demand valve (CDV) 120. The plenum cap 114 is attached to the plenum body 112 to form a plenum body assembly 124 (see FIG. 11). Plenum body assembly 124 has a mask end 126 and a hose end 128. At the mask end 126, the plenum body 112 includes connector seat that is formed by sleeve 122, upon which the connector 118 can be seated. At the hose end 128, the plenum body assembly 124 is sealingly attached to the flexible gaiter 116. The plenum 110 can be fluidly connected to a respirator mask 22 and air hose 24 and can be formed in hard plastic that is National Fire Protection Association (NFPA) and Chemical, Biological, Radiological, and Nuclear (CBRN) compliant, or in any other suitable material.

Referring to FIG. 9, the main plenum body 112 comprises an enclosed segment 130, which includes the sleeve 122, and an open segment 132. The enclosed segment 130 is hollow, and can have any cross-sectional configuration, but is preferably ovate. In the embodiment shown, the cross-section of the enclosed segment 130 is generally elliptical. The open segment 132 is an extension of the enclosed segment 130, with approximately one half of the cross-section removed.

The sleeve 122 is formed in the plenum body 112 and includes a ridge 134 around its outer periphery and a multiplicity of axial slots 135 forming fingers 136 which flex somewhat. Both the ridge 134 and fingers 136 are features designed to enable the assembly and retention of the connector 118, as described in detail below. The outer periphery of the sleeve 122 further includes two circumferential grooves 156 and 158.

Referring to FIG. 10, the plenum cap 114 is generally arcuate and forms the mating portion to the open segment 132 of the plenum body 112. The plenum cap 114 can be sealingly attached to the open segment 132 by any suitable means, effectively enclosing the open segment 132. For example, the mating edges of the plenum cap 114 and open segment 132 can be joined together utilizing a half lap joint and an adhesive with which to seal the joint. The plenum cap 114 also includes a hole 144 through which the compact demand valve 120 can be inserted. The hole 144 is located on a slightly raised portion of the cap 114 in order to provide a planar surface on which the valve 120 can be seated. The hole 144 is generally formed to be of similar size and shape to the compact demand valve 120 and provides a shoulder 145 to which the valve 120 can be retained.

Referring to FIG. 11, the plenum body assembly 124 has an inlet 137 defined by the opening at hose end 128 of the assembled plenum body 112 and cap 114. The plenum body assembly 124 also has an outlet 123 that is defined by the sleeve 122 and that fluidly connects the plenum 110 to the mask 22.

Referring to FIG. 12, the connector 118 is comprised of a swivel plate 138 and an externally threaded sleeve 140, which is advantageously used to couple the plenum 110 to the internally threaded inlet (not shown) of a respirator mask 22. The threaded sleeve 140 portion of the connector 118 is tubular and has a circumferential tab 142 on the interior of the threaded sleeve 140.

Referring now to FIG. 13, a cross-sectional view of the plenum 110 with the assembled connector 118 and sleeve 122 is shown. When assembling the connector 118 to the sleeve 122, the fingers 136 on the sleeve 122 flex inward, enabling connector 118 tab 142 to pass by the ridge 134 of the sleeve 122. Once installed, the fingers 136 snap back into their original position and the tab 142 seats below the bottom of the ridge 134 to retain the connector 118 to the sleeve 122. The connector 118 is thus rotatably mounted on the sleeve 122, providing a means by which the user can threadably couple the connector 118 to the mask 22. Two o-rings 160 and 162 can be seated, one each, in the grooves 156 and 158 about the circumference of the sleeve 122, thus sealing the connector 118 to the sleeve 122.

As shown in FIG. 13, the plenum 110 includes a compact demand valve 120. The compact demand valve 120 is seated on the shoulder 145 of the plenum cap 114. A portion of the valve 120 passes through the hole 144 and is retained to the cap 114 by a conventional snap ring 147. The compact demand valve 120 controls the supply of air by opening to provide airflow when the user inhales and closing, thereby shutting off the airflow, when the inhalation stops. Compact demand valves are well known in prior art, and are not germane to the invention; thus the demand valve will not be further discussed herein.

Referring again to FIG. 8, the gaiter 116 is shown. The gaiter 116 is defined by a flexible corrugated conduit 146 having a collar 148, and can be formed in plastic, rubber, or any other suitable flexibly material. In the embodiment shown, the gaiter 116 does not include an elbow; however, incorporating an elbow, similar to the first embodiment, can be incorporated according to the invention. The gaiter 116 is hollow and generally ovate; the cross-section of the conduit 146 gradually transitions from circular at one end, to an ellipse at the opposite end. The ends of the gaiter 116 match that of the cross-sections of the hose 24 and plenum body assembly 124 in order to fluidly connect to the plenum body assembly 124 at one end, and to the hose 24 at the other end. The conduit 146 terminates in a collar 148 to which the hose 24 can be sealed. The hose 24 and collar 148 are clamped together by a conventional ring clamp. However, other suitable methods are feasible by which to fluidly connect the hose 24 and gaiter 14, for example a threaded engagement. The opposite end of the gaiter 116 is sealed to the plenum body assembly 124 in any suitable air-tight fashion.

In operation, the hose 24 can be connected to a SCBA. The plenum 110 is coupled to the hose 24 as described above. The connector 118 of the plenum 110 is attached to the mask 22 as described above. The hose 24, plenum 110, and mask 22 are thus sealingly and fluidly connected and can provide the wearer with a source of breathable air from the SCBA.

Referring back to FIG. 7, the respirator's air flow path is illustrated. Air flows from the PAPR or SCBA, through the hose 24 and gaiter 116, into the plenum body assembly 124, through the sleeve 122, out through outlet 123, and finally into the inlet of the mask 22 and to the wearer.

Referring back to FIGS. 7 and 8, the plenum 110 may optionally include a remote power switch 152 by which power to a PAPR, or other powered device, may be controlled. The power switch 152 can be located in a split opening 154, one half of which is formed in each of the plenum body 112 and plenum cap 114. The opening 154 can include a slot 155 into which the remote power switch 152 can be inserted. Assembling the plenum cap 114 to the plenum body 112 sandwiches the remote power switch 152 in the slot 155.

The respirator and contoured plenum 10, 110 of the invention may also optionally include such features as hydration and heads up display, as shown in FIG. 1. To provide hydration to the wearer requires a hydration bottle 164 and a hydration tube 166. The hydration tube 166 is connected to the bottle 164 and is routed along the path of the hose 24. The tube 166 is connected to the mask 22, as is well known in the art. The tube 166 can be retained to the hose 24, by a multiplicity of clips 168, for example, which are attached to the hose 24 and plenum 10 by adhesive, or any other suitable means. Other means for retaining the tube 166 to the hose 24 are feasible also. Routing the hose 24 and the tube 166 together simplifies the respirator system and prevents tangling.

Similarly, the heads up display requires a light source (not shown), which is typically housed within the air supplying device 23, and a light pipe 170. The light pipe 170 is connected to the light source and is routed along the path of the hose 24. The light pipe 170 is connected to the mask 22, as is well known in the art. The light pipe 170 can be retained to the hose 24 in the same fashion as described above, using clips 168 or other suitable means.

The respirator and contoured plenum 10 of the invention facilitate the movement of air from a PAPR or SCBA to a mask 22 or hood and replace the need for the conventional rubber hose interface traditionally associated with powered air devices. The plenum 10 is contoured to closely follow the profile of the mask 22, reducing the profile of the airway into the mask 22. The low profile design of the plenum 10 reduces the risk of an attacker grabbing the hose and dislodging the mask 22 or closing off the airway. There are many other benefits to this plenum, including positioning the interface between the hose 24 and the mask 22 behind the wearer's neck, which eliminates the need for a longer hose 24, reducing the weight on the mask 22. The respirator also then uses a shorter hose 24 and provides additional mounting methods for the PAPR. Rather, it manages the hose 24 position to ensure that there is no trapping of the hose 24, and helps to prevent snagging. The plenum 10 can swivel to adjust to up and down with the head movement by the user. The plenum 10 can also be used as a modular connector for different hose lengths and integrated components such as an integrated power switch, heads up display, or compact demand valve. These and many other unnamed benefits can be realized through use of the invention respirator kit and and contoured plenum according to the invention.

While the invention has been specifically described in connection with certain specific embodiments thereof, it is to be understood that this is by way of illustration and not of limitation. Reasonable variation and modification are possible within the scope of the forgoing disclosure and drawings without departing from the spirit of the invention which is defined in the appended claims.

1. A respirator kit comprising:
a respirator mask having an inlet opening for admitting air into the mask;
a source of pressurized air; and
a hose adapted to be connected to the source of pressurized air at one end and having a distal end;
a plenum having a mask end that is adapted to be connected to the mask inlet opening and a hose end that is adapted to be connected to the hose distal end and wherein the plenum is configured to be positioned alongside a side of the mask along the length of the plenum when the plenum mask end is connected to the mask inlet opening.

2. A respirator kit according to claim 1 wherein the mask has a hose/filter connector for affixing a filter canister or air supply hose at the inlet opening thereof and the plenum mask end has a mask connector that is adapted to connect the plenum to the hose/filter connector.

3. A respirator kit according to claim 2 wherein the mask connector is integrated into the plenum to provide a low-profile connection between the mask and the plenum.

4. A respirator kit according to claim 3 wherein the mask connector is rotatably mounted to the plenum so that the plenum can rotate with respect to the mask about the hose/filter connector when the plenum is connected to the mask.

5. A respirator kit according to claim 4 wherein the plenum has a connector seat and the mask connector is rotatably mounted in the connector seat.

6. A respirator kit according to claim 5 and further comprising a seal between the connector seat and mask connector.

7. A respirator kit according to claim 5 wherein the plenum connector seat is clamped between the mask connector and the hose/filter connector.

8. A respirator kit according to claims 4 wherein the mask connector has a handle on an exterior surface of the mask connector for rotating the mask connector with respect to the plenum.

9. A respirator kit according to claim 4 wherein the hose/filter connector and mask connector have complementary bayonet connections.

10. A respirator kit according to any of claims 4 wherein the hose/filter connector and mask connector have complementary threaded connections.

11. A respirator kit according to claim 5 wherein the plenum connector seat comprises a seat sleeve to which the mask connector is mounted.

12. A respirator kit according to claim 11 wherein the mask connector comprises a connector sleeve which is received over the plenum seat sleeve.

13. A respirator kit according to claim 12 wherein the mask connector sleeve is axially retained on the plenum seat sleeve but rotatably mounted thereto.

14. (canceled)

15. (canceled)

16. (canceled)

17. (canceled)

18. (canceled)

19. (canceled)

20. (canceled)

21. (canceled)

22. A respirator kit according to claim 1 and further comprising a demand valve mounted on the plenum and adapted to control the flow of air through the plenum.

23. A respirator kit according to claim 1 and further comprising a remote power switch that is mounted on the plenum and is adapted to control power to the source of pressurized air.

24. A respirator kit according to claim 1 and further comprising a hydration tube mounted to the plenum and adapted to be connected to the mask.

25. A respirator kit according claim 1 and further comprising a light pipe mounted to the plenum and adapted to be connected to the mask.

26. A low-profile plenum for use with a respirator comprising a mask end that is adapted to be connected to a mask inlet opening and a hose end that is adapted to be connected to a hose distal end and wherein the plenum is configured to be positioned alongside a side of the mask along the length of the plenum when the plenum mask end is connected to the mask inlet opening.

27. A low-profile plenum according to claim 26 wherein the plenum mask end has a mask connector that is adapted to connect the plenum to a mask hose/filter connector.

28. A low-profile plenum according to claim 27 wherein the mask connector is integrated into the plenum to provide a low-profile connection between the mask and the plenum; and the mask connector is rotatably mounted to the plenum so that the plenum can rotate with respect to the mask when the plenum is connected to the mask.

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)
